(19) United States
(12) Patent Application Publication
(10) Pub. No.: US 2004/0064445 A1
(43) Pub. Date: Apr. 1, 2004

(54) Wireless access to a database by a short message system query

(76) Inventors: Gerald W. Pfleging, Batavia, IL (US); Rachel M. Pfleging, Batavia, IL (US); George Paul Wilkin, Bolingbrook, IL (US)

Correspondence Address: PATTI & BRILL, ONE NORTH LASALLE STREET, 44TH FLOOR, CHICAGO, IL, 60602, US

(21) Appl. No.: 10/390,079

(22) Filed: Mar. 17, 2003

Related U.S. Application Data
(60) Provisional application No. 60/414,792, filed on Sep. 30, 2002.

(51) Int. Cl. G06F 17/30

(52) U.S. Cl. 707/3

(57) ABSTRACT

Information is obtained from a database based on a query from a wireless subscriber's device that does not support direct communications with the database. A first e-mail message containing the first query is received at a workstation. Determined from the first e-mail message are the address of the first subscriber, whether the subscriber has a limited bandwidth capability, and the requested information by the subscriber. A response to the requested information is obtained from a database. The response is parsed in accordance with predetermined rules to limit the amount of data contained in a second message if the subscriber has been determined to have a limited bandwidth capability. The second message is transmitted to the first subscriber's address.

### RELATED APPLICATION

This application claims priority on application serial No. 60/414,792 entitled “Internet Based DVD Information and Collection Manager”, filed Sep. 30, 2002.

### BACKGROUND

Wireless services continue to grow in popularity. Although voice communications facilitated by wireless cellular telephones remains the dominant service utilized by subscribers, wireless data services continue to rise in popularity. This growth in popularity is at least in part due to the increased availability of affordable data-enabled wireless devices including cellular telephones with short message service (SMS) capability, personal digital assistants with wireless data capabilities, and portable computers equipped with wireless modems. SMS messages are a popular form of communication among some users.

A multitude of databases are connected to and are accessible by the Internet. For example, Internet sites that serve as search engines for Internet users maintain a large database of indexed words collected from sites across the Internet. In response to a query from an Internet user, the search engine uses a search algorithm to locate the most relevant indexed words in its database and reports at least a portion of the record associated with each hit to the user. Some Internet databases, especially those that are directed to business and professional users, are accessible only on a subscription basis. The Internet databases typically require the user to interact with the database by TCP/IP protocol and have device that runs a Web browser. U.S. Pat. No. 5,978,799 describes a search engine tool that permits access to databases by the Internet. A wireless Internet user employing a laptop computer running an Internet browser and connected by a wireless modem will appear as any other Internet user from the perspective of an Internet accessible database. However, a wireless subscriber using a cellular telephone that is data-enabled via SMS capability will not be able to directly access information from Internet databases. Thus, there exists a need to provide communication services between data-enabled cellular users and databases accessible by the Internet.

### SUMMARY OF THE INVENTION

It is an object of the present invention to provide a solution to the problem of providing communication services between a data-enabled, but not direct Internet access enabled, wireless devices and databases accessible by the Internet.

In accordance with an exemplary method of the present invention, a method is provided for accessing a database based on a first query from a wireless subscriber. A first e-mail message is received at a workstation where the first e-mail message consists of the query having been converted into an e-mail message. The first e-mail is parsed and a determination is made of the address of the first subscriber, the requested information, and whether the requester has a bandwidth limited capability. A second query based on the requested information is generated and transmitted to the database. A response from the database to the second query is received and parsed in accordance with predetermined rules to limit the amount of data contained in a second message that is transmitted to the first subscriber's address.

### BRIEF DESCRIPTION OF THE DRAWINGS

FIG. 1 is a block diagram of a telecommunications system suited for incorporating an embodiment of a method in accordance with the present invention.

FIGS. 2A and 2B are flow diagrams illustrating steps in accordance with an embodiment of the present invention.

FIG. 3 illustrates the format of an exemplary subscriber query in accordance with the present invention.

FIG. 4 illustrates a command and search criteria format in accordance with FIG. 3.

FIG. 5 illustrates an exemplary message responding to the subscriber's query.

### DETAILED DESCRIPTION OF EMBODIMENT

The exemplary method of the present invention addresses providing access to a remote database for a wireless subscriber using a device that does not support the communication format and/or capability required for direct communications with the database. In accordance with the exemplary method, the device used by the wireless subscriber is data-enabled, but cannot support direct communications with the database. For example, such a wireless device could be, but is not limited to, a data-enabled cellular telephone without direct Internet access capabilities, e.g. a cellular telephone with SMS capability, or a cellular telephone with GSM data capabilities. It will be apparent that a wireless subscriber using a laptop computer with an Internet browser and a wireless modem with direct communication capabilities with the Internet is outside the scope of the exemplary method of the present invention.

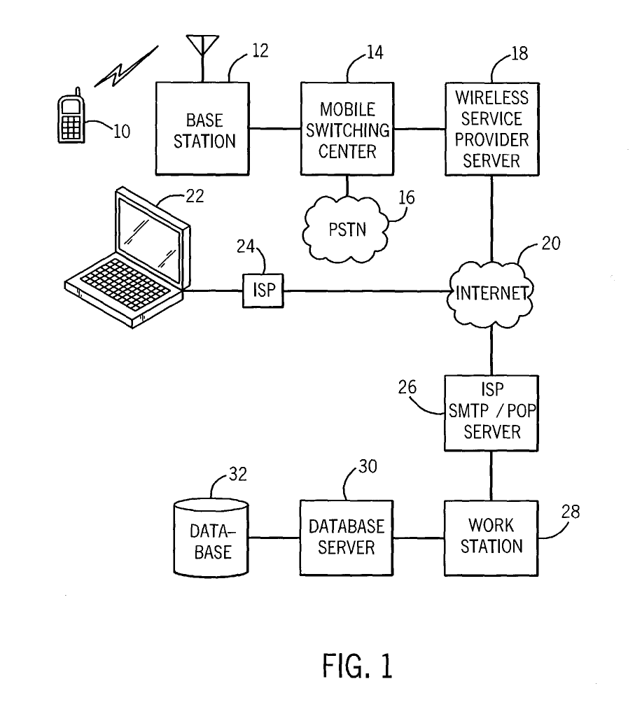

Referring to FIG. 1, a wireless device 10, e.g. a cellular telephone with SMS capabilities, is utilized by a subscriber for voice and data communications. A base station 12 provides a radio frequency link and supports communications with wireless device 10. A mobile switching center 14 is connected to base station 12, the public switched telephone network (PSTN) 16 and a wireless service provider's server 18. The mobile switching center 14 facilitates the handling of telephone calls and data communications that traverse base station 12. The wireless service provider's server 18 is operated by the provider of wireless communication (cellular) services and can terminate data communications received from wireless device 10, originate data communications transmitted to wireless device 10, and route data communications between wireless device 10 and the Internet 20. In providing the routing function, server 18 also functions as an interface between the communication protocols used for SMS communications by wireless device 10 and communications with the Internet 20, e.g. TCP/IP communications.

The Internet 20 also supports conventional users such as a user of laptop computer 22. This user subscribes to an Internet service provider 24 that facilitates communications between the user and Internet 20. Another Internet service provider provides services by a simple mail transfer protocol/point of presence (SMTP/POP) server 26 that supports Internet communications including e-mail for a user or database service provider associated with workstation 28. The workstation 28 may consist of a computing facility commonly referred to as a workstation or a personal computer with sufficient data throughput capabilities to handle the volume of database queries of the exemplary method of the present invention as will be described below. The workstation 28 is connected to a database server 30 that is in turn connected to database 32. The database 32 contains one or more collections of related information with each collection of information containing a plurality of records with a plurality of fields. For example, the database may contain information relating to works available on digital video disk (DVD) and may also include user specific information related to a DVDs such as the specific DVDs owned by the user or placed on order for purchase. Depending upon the computing power and throughput available, it will be apparent to those skilled in the art that workstation 28 and database server 30 could be integrated into a single computing apparatus. The information in the database 32 can be organized, controlled, and accessed under the control of commercially available database software.

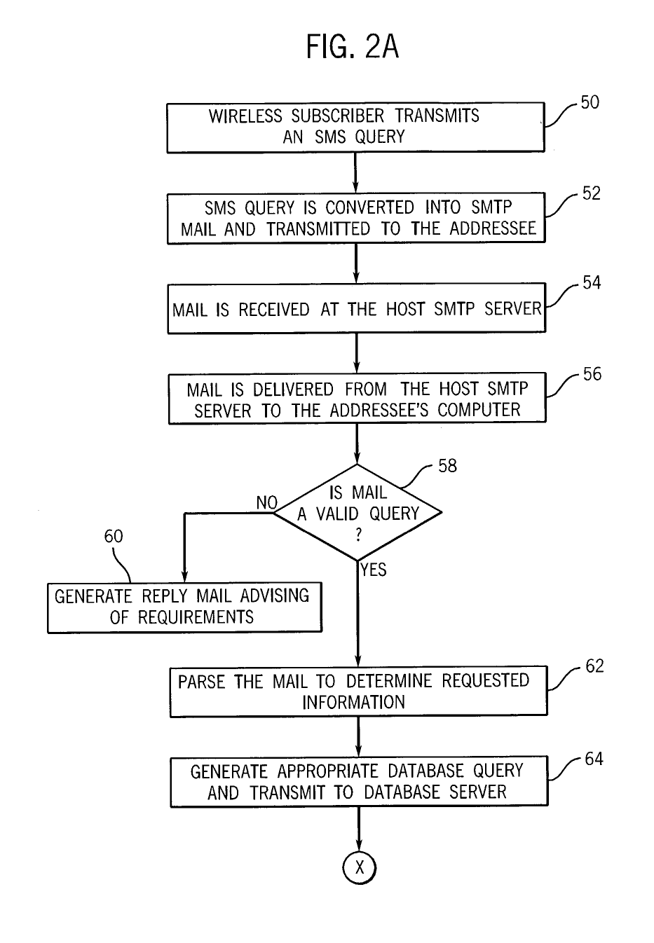

Referring to FIGS. 2A and 2B, a flow diagram of an exemplary method in accordance with the present invention is explained. In step 50 a subscriber transmits a message carrying a query using the SMS data capabilities of wireless device 10. The message is addressed to the e-mail address of workstation 28. The message carrying the SMS query is received at server 18 where it is converted into SMTP e-mail and transmitted by Internet 20 to the addressee in step 52. The e-mail message containing the query is received at the host SMTP server 26 in step 54. Upon the server 28 receiving a request from workstation 28, this e-mail message is delivered from server 26 to the addressee workstation 28 in step 56. The workstation 28 upon receiving the e-mail message makes a determination of whether the e-mail contains a valid query at step 58. A NO determination by step 58 causes a reply e-mail message to be transmitted to the requester advising of the requirements for a valid query in step 60. This terminates further processing of the received message. A YES determination by step 58 causes the parsing of the e-mail message to determine information requested by the user at step 62. The workstation 28 generates an appropriate database query based on the parsed e-mail message and transmits it to the database server 30 at step 64.

The database server 30 retrieves corresponding information from database 32 based on the query received from workstation 28 and transmits the corresponding information to the workstation at step 66. If the information request originated from a user with a limited bandwidth capability, workstation 28 parses the information received from database server 30 to restrict the quantity of data to be transmitted to the requester in step 68. A user with limited bandwidth capability can be determined by various techniques such as determining that the e-mail address of the requester identifies the requester as using the SMS capability of a cellular telephone. The combination of the individual address of the user being a cellular telephone number and/or the domain portion of the address identifying a wireless cellular provider that supports limited bandwidth service, e.g. SMS, can be utilized to make the decision of whether the requester has limited bandwidth capability.

Workstation 28 generates a reply e-mail message addressed to the requester containing the parsed database information and transmits the reply message by the Internet in step 70. The reply e-mail message is received at the wireless service provider's server 18 where it is converted into an appropriate SMS message format by step 72. This SMS message is then transmitted from server 18 by mobile switching center 14 and base station 12 to the user of wireless device 10 at step 74. On receiving the reply message, wireless device 10 displays the received data information on its screen for viewing by the requester in step 76.

In an illustrative example, the requester is in a store that rents DVD movies and desires information related to a movie or DVD to assist in selecting a DVD movie to rent. The requester normally likes movies starring the actor, Tom Cruise. The requester utilizes cellular telephone 10 to transmit an SMS message to the known address of workstation 28 containing a query for all recent movies on DVD with Tom Cruise. A short time after transmitting this request, a reply SMS message is received listing a series of movie titles that are released on DVD that include Tom Cruise as a cast member. The requester can utilize this information to assist in making a decision on which DVD to rent.

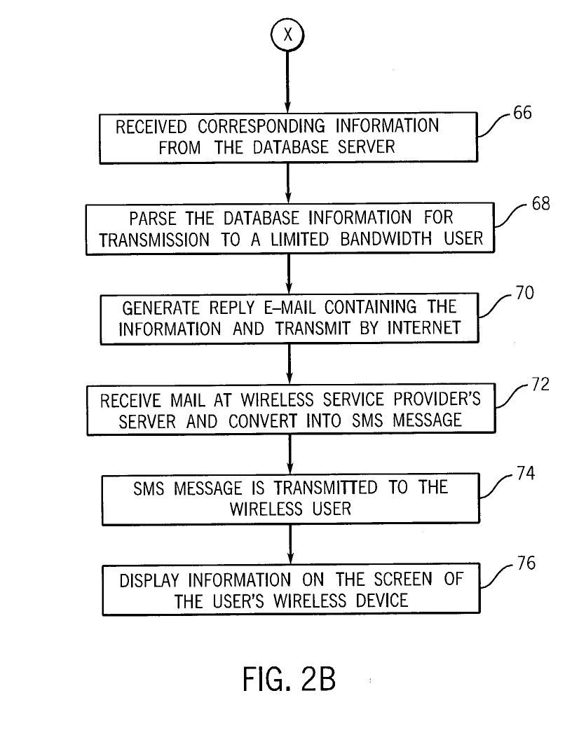

FIG. 3 illustrates an exemplary e-mail message header in accordance with an embodiment of the present invention. The wireless user desiring to make a query of the database information will know the e-mail address of the service provider for such services. Also the wireless user must know or obtain information from the database service provider, the format and type of information required to comprise a valid query. The “To:” field illustrates the e-mail address of the database service provider and the “Subject:” field illustrates the format required for a query. In accordance with the exemplary embodiment, the query itself is contained within the Subject field that will be explained in more detail below. The “From:” field is the e-mail address of the requester. As will be known to those skilled in the art, a subscriber using a cellular telephone with SMS capabilities will enter the information in the To and Subject fields. Upon receiving the SMS message, the wireless service provider's server 18 will recognize that the addressee is outside of the service provider's direct network and generate an e-mail message shown in FIG. 3 for transmission to the Internet. Based on information contained in the received SMS message, server 18 will recognize the identity of the wireless subscriber and will add the subscriber's address to the From field before transmitting the e-mail message to the Internet.

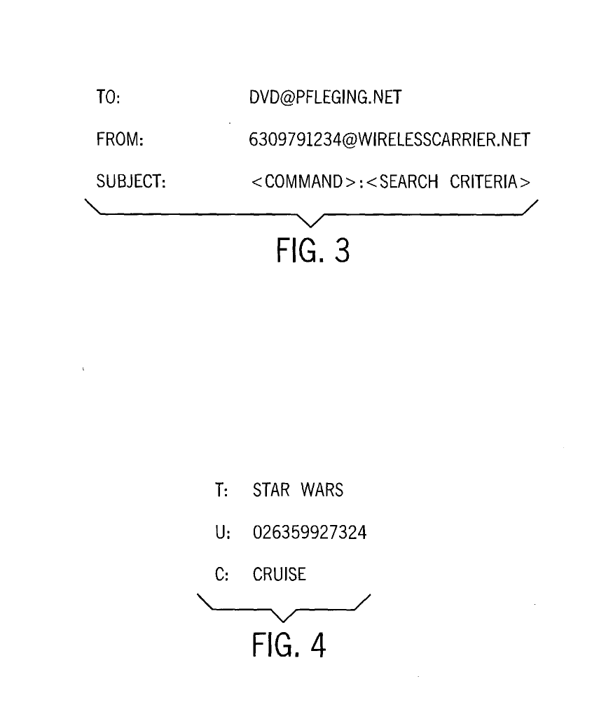

FIG. 4 illustrates exemplary “<command>” information as shown in FIG. 3. In the illustrative example, the Command information designates the type of field or index to be searched in the database. The “<search criteria>” of FIG. 3 designates user supplied information on which a search of the corresponding Command index will be based. Thus, “T: Star Wars” represents a request to search the title index for the movie “Star Wars”. The request “U: 026359927324” is a request to search the universal product code (UPC) index for the product with the UPC code of 026359927324. The request “C: Cruise” is a request to search the cast index for a cast member with the name “Cruise”. Although the illustrative embodiment illustrates the use of a single command and search criteria combination, it will be apparent that more than one set of command/search criteria requirements could be utilized to more specifically target a specific entry (DVD movie), or could consist of multiple unrelated search requests.

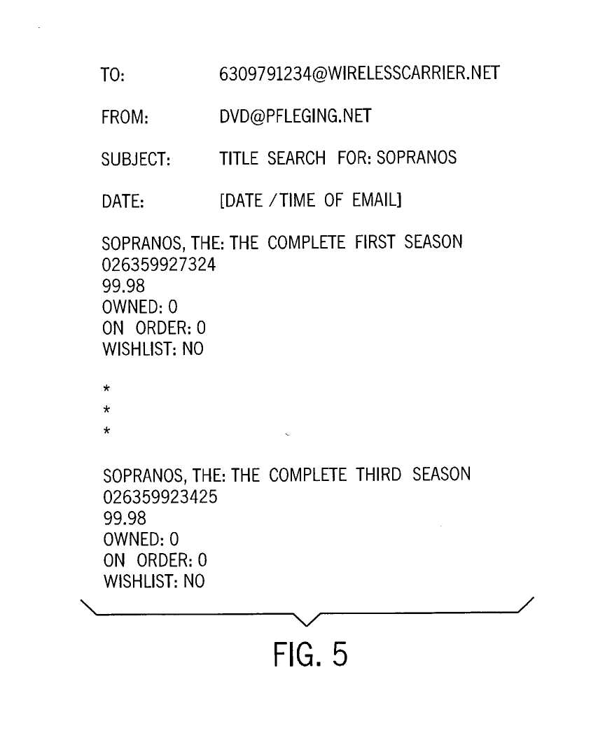

FIG. 5 illustrates an exemplary reply e-mail generated by workstation 28 based on database search results in response to a query of “T: Sopranos” from the wireless subscriber. The query constitutes a request for a search of DVD available titles with “sopranos”. A search of the DVD title index of database 32 resulted in three records being found that matched the search criteria, corresponding to the first, second, and third television seasons of “The Sopranos” (only the first and third records are shown in FIG. 5). The “To:” field is the e-mail address of the requester; the “From:” field is the e-mail address of the database service provider supported by workstation 28; the “Subject:” field confirms the search conducted; the “Date:” field contains the time and date that the e-mail was sent by the database service provider. The body of the reply e-mail shown in FIG. 5 contains information contained in records found by the search. The illustrative body of the e-mail may not contain all information contained in the database for each record found by the search since the requester will have been determined to be a limited bandwidth user due to accessing the system using SMS messaging capability. A predetermined maximum parameter stored at the workstation may limit the amount of data included in the e-mail response transmitted to the requester. Further, data types of different categories, i.e. pictures/graphics as compared to ASCII alphanumeric characters, can be used to limit the data to be transmitted to the requester, such as by deleting any pictures/graphics since these types typically require substantially more bandwidth for transmission. Thus, graphics or pictures associated with a record found by the search may be deleted by predetermined rules stored in workstation 28 in order to reduce the required bandwidth and demands on the wireless device's display capabilities. Depending on the requirements of the user, the display and memory capabilities of the subscriber's wireless device, the bandwidth made available to the user by the wireless service provider, and the amount of data stored in the database that is associated with the search, the predetermined rules can parse the search results to provide the most relevant information that can be contained in the reduced data to be transmitted to the requester.

The body of the e-mail illustrated in FIG. 5 includes for each of the three located records the title, UPC code, price, and fields indicating whether the DVD is Owned by the requester, whether the DVD is On Order by the requester, and whether the DVD is on a Wish List to be owned by the requester. Obviously the database in this illustrative example contains not only general information concerning DVD's, but also contains requester specific information that will have been previously obtained from the requester and entered into the database.

It will be apparent to those skilled in the art that a variety of modifications could be made to the illustrative embodiment. Information on different subjects can be stored and indexed in the same database or in separate databases. Depending upon the subject matter of the database and the nature of information typically sought by requesters, various commands and search criteria could be used. Wireless devices, in addition to cellular telephones with SMS data capabilities, that lack the ability to direct to communicate with the database will benefit from the present invention. The capabilities of the workstation and database server of the illustrative embodiment can be combined into a single device or integrated with another device such as server 18 or 26 provided that the combined device has the required computing power and bandwidth capabilities. Although the illustrative embodiment of the present invention has been described above and shown in the drawings, the scope of the invention is defined by the claims that follow.

We claim:

1. A method for obtaining information from a database based on a first query from a wireless subscriber's device that does not support direct communications with the database comprising the steps of:
receiving at a workstation a first e-mail message containing the first query;
parsing the first e-mail message and determining the address of the first subscriber, whether the subscriber has a limited bandwidth capability, and the requested information by the subscriber;
obtaining from a database a response to the requested information;
parsing the response from the database in accordance with predetermined rules to limit the amount of data contained in a second message if the subscriber has been determined to have a limited bandwidth capability;
transmitting the second message to the first subscriber's address.

2. The method according to claim 1 wherein the step of determining the requested information comprises the steps of determining a first command contained in the first e-mail, the first command being one of a group of predetermined commands stored at the workstation, and determining a search criteria entered by the subscriber associated with the first command.

3. The method according to claim 2 wherein the first command and search criteria are contained in a subject line in a header of the first e-mail message.

4. The method according to claim 2 wherein the step of obtaining comprises using the first command to identify an index of the database to be searched, and using the search criteria as the term to be searched for in the index of the database.

5. The method according to claim 1 wherein the step of parsing the response from the database in accordance with predetermined rules to limit the amount of data contained in a second message comprises limiting the amount of data contained in the second message to a predetermined maximum amount data.

6. The method according to claim 1 wherein the step of parsing the response from the database in accordance with predetermined rules to limit the amount of data contained in a second message comprises limiting the amount of data contained in the second message by determining the categories of information contained in the response from the database and not including predetermined types of categories of information in the second message.

7. The method according to claim 1 further comprising the step of determining the first e-mail message to be a valid query for the database.

8. The method according to claim 7 wherein the step of determining the first e-mail message to be a valid query for the database comprises determining that a valid first command is contained in a subject line heading of the first e-mail.

9. The method according to claim 1 wherein the step of determining whether the subscriber has a limited bandwidth capability comprises determining that the first query originated from a wireless telecommunication subscriber.

10. The method according to claim 1 wherein the first query is transmitted by a short messaging service message from the wireless device.

11. A method for obtaining information from a database comprising the steps of:
receiving a first query from a wireless subscriber's device that does not support direct communications with the database at a wireless service provider's server;
converting the query into a first e-mail message containing the first query and transmitting the first e-mail to the Internet;
receiving at a workstation coupled to the Internet the first e-mail message;
parsing the first e-mail message and determining the address of the first subscriber, whether the subscriber has a limited bandwidth capability, and the requested information by the subscriber;
obtaining from a database a response to the requested information;
parsing the response from the database in accordance with predetermined rules to limit the amount of data contained in a second message if the subscriber has been determined to have a limited bandwidth capability;
transmitting the second message to the first subscriber's address.

12. The method according to claim 11 wherein the step of determining the requested information comprises the steps of determining a first command contained in the first e-mail, the first command being one of a group of predetermined commands stored at the workstation, and determining a search criteria entered by the subscriber associated with the first command.

13. The method according to claim 12 wherein the first command and search criteria are contained in a subject line in a header of the first e-mail message.

14. The method according to claim 12 wherein the step of obtaining comprises using the first command to identify an index of the database to be searched, and using the search criteria as the term to be searched for in the index of the database.

15. The method according to claim 11 wherein the step of parsing the response from the database in accordance with predetermined rules to limit the amount of data contained in a second message comprises limiting the amount of data contained in the second message to a predetermined maximum amount data.

16. The method according to claim 11 wherein the step of parsing the response from the database in accordance with predetermined rules to limit the amount of data contained in a second message comprises limiting the amount of data contained in the second message by determining the categories of information contained in the response from the database and not including predetermined types of categories of information in the second message.

17. The method according to claim 11 further comprising the step of determining the first e-mail message to be a valid query for the database.

18. The method according to claim 17 wherein the step of determining the first e-mail message to be a valid query for the database comprises determining that a valid first command is contained in a subject line heading of the first e-mail.

19. The method according to claim 11 wherein the step of determining whether the subscriber has a limited bandwidth capability comprises determining that the first query originated from a wireless telecommunication subscriber.

20. The method according to claim 11 wherein the first query is transmitted by a short messaging service message from the wireless device.
